(19) United States
(12) Patent Application Publication
(10) Pub. No.: US 2021/0008917 A1
(43) Pub. Date: Jan. 14, 2021

(54) THERMOSENSITIVE RECORDING MEDIUM, THERMOSENSITIVE RECORDING MEDIUM PRODUCING METHOD, AND ARTICLE

(71) Applicants: Gaku KOHARA, Shizuoka (JP); Yasuhiro KADOTA, Shizuoka (JP)

(72) Inventors: Gaku KOHARA, Shizuoka (JP); Yasuhiro KADOTA, Shizuoka (JP)

(21) Appl. No.: 16/955,520

(22) PCT Filed: Dec. 21, 2018
(86) PCT No.: PCT/JP2018/047154

§ 371 Date: Jun. 18, 2020

(30) Foreign Application Priority Data
Dec. 22, 2017 (JP) 2017-246998

(51) Int. Cl. B41M 5/44; B41M 5/41; B41M 7/00

(52) U.S. Cl. CPC B41M 5/44; B41M 5/41; B41M 2205/40; B41M 2205/04; B41M 7/0045

(57) ABSTRACT

Provided is a thermosensitive recording medium including: a transparent base material; a thermosensitive recording layer over the transparent base material; and a barrier layer over the thermosensitive recording layer, wherein the barrier layer contains hollow particles and a binder resin, and wherein when thermal energy is applied to the thermosensitive recording layer from a surface of the thermosensitive recording layer having the transparent base material, the thermosensitive recording layer develops a color. Also provided is a thermosensitive recording medium producing method including: a step of forming a thermosensitive recording layer over a transparent base material; and a step of forming a barrier layer containing hollow particles and a binder resin over the thermosensitive recording layer.

### TECHNICAL FIELD

The present disclosure relates to a thermosensitive recording medium, a thermosensitive recording medium producing method, and an article.

### BACKGROUND ART

Thermosensitive recording media are widely used in many fields such as the field of POS for, for example, perishable foods, box lunches, and delicatessen, the field of copying of, for example, books and documents, the field of communication such as facsimile, the field of ticketing such as ticketing machines, receipts, and signed receipts, and baggage tags in the airline industry. In addition to these usages, thermosensitive recording media are used for, for example, labels for drug management, labels for analyte management, and labels for process management.

Particularly, for usages as, for example, labels for drug management, labels for analyte management, and labels for process management, thermosensitive recording media having excellent performance in, for example, solvent resistance and scratch resistance are needed in order to maintain the indications on the labels for a long term.

For example, in order to increase solvent resistance and scratch resistance, there is proposed a thermosensitive recording medium including a resin-made protective layer over a thermosensitive recording layer (for example, see PTL 1).

There is also proposed sequential lamination of a resin film and a silicone film over a thermosensitive recording layer to improve water resistance, oil resistance, and scratch resistance (for example, see PTL 2).

### CITATION LIST

### Patent Literature

PTL 1: Japanese Unexamined Patent Application Publication No. 2002-11956
PTL 2: Japanese Unexamined Patent Application Publication No. 07-25142

### SUMMARY OF INVENTION

### Technical Problem

The present disclosure has an object to provide a thermosensitive recording medium excellent in solvent rub resistance, color developing sensitivity, visibility, and temporal color fade resistance.

### Solution to Problem

According to one aspect of the present disclosure, a thermosensitive recording medium includes a transparent base material, a thermosensitive recording layer over the transparent base material, and a barrier layer over the thermosensitive recording layer. The barrier layer contains hollow particles and a binder resin. When thermal energy is applied to the thermosensitive recording layer from a surface of the thermosensitive recording layer having the transparent base material, the thermosensitive recording layer develops a color.

### Advantageous Effects of Invention

The present disclosure can provide a thermosensitive recording medium excellent in solvent rub resistance, color developing sensitivity, visibility, and temporal color fade resistance.

### BRIEF DESCRIPTION OF DRAWINGS

FIG. 1 is a schematic view illustrating an example of a thermosensitive recording medium of the present disclosure.

FIG. 2 is a schematic view illustrating another example of a thermosensitive recording medium of the present disclosure.

FIG. 3 is a schematic view illustrating another example of a thermosensitive recording medium of the present disclosure.

FIG. 4 is a schematic view illustrating another example of a thermosensitive recording medium of the present disclosure.

### DESCRIPTION OF EMBODIMENTS

(Thermosensitive Recording Medium)

A thermosensitive recording medium of the present disclosure includes a transparent base material, a thermosensitive recording layer over the transparent base material, and a barrier layer over the thermosensitive recording layer. The barrier layer contains hollow particles and a binder resin. When light or thermal energy is applied to the thermosensitive recording layer from the surface of the thermosensitive recording layer having the transparent base material, the thermosensitive recording layer develops a color. The thermosensitive recording medium further includes other layers as needed.

The thermosensitive recording medium of the present disclosure is based on the following finding. With existing thermosensitive recording media, printed information fades away over time, and commercial values decrease. This makes misrecognition-free, appropriate management difficult in the usages in, for example, drug management, analyte management, and process management.

The thermosensitive recording medium of the present disclosure can be improved in solvent rub resistance, color developing sensitivity, visibility, and temporal color fade resistance, by having a layer configuration in which the transparent base material is provided to constitute the surface of the thermosensitive recording medium on the recording surface side.

<Transparent base material>

The transparent base material is not particularly limited, and the shape, structure, average thickness, and material of the transparent base material may be appropriately selected depending on the intended purpose so long as the transparent base material has transparency that enables an image printed on the thermosensitive recording layer to be visible and solvent resistance to an organic solvent.

In the present disclosure, the transparency refers to a property defined by a haze degree measured according to ASTM D1003 or ISO 14782. The haze degree is preferably 30% or lower and more preferably 10% or lower.

The method for measuring the haze degree is not particularly limited and may be appropriately selected depending on the intended purpose. Example of the method include a haze meter (instrument name: HZ-V3, available from Suga Test Instruments Co., Ltd.).

In the present disclosure, the solvent resistance mainly refers to resistance to an organic solvent. Examples of the organic solvent include alcohols such as ethanol, methanol, butanol, and propanol, ketones such as acetone and MEK (methyl ethyl ketone), aromatic hydrocarbons such as toluene and xylene, and esters such as ethyl acetate and butyl acetate. One of these organic solvents may be used alone or two or more of these organic solvents may be used in combination.

The material of the transparent base material is not particularly limited so long as the material has the solvent resistance described above. Examples of the material include inorganic materials, organic materials, and inorganic-organic hybrid materials. Here, examples of organic materials include films formed of plastic materials such as polyester resins such as polyethylene terephthalate (PET), polycarbonate, polystyrene (PS), polymethyl methacrylate (PMMA), polyethylene (PE), and polypropylene (PP) (hereinafter, referred to as plastic film). One of these organic materials may be used alone or two or more of these organic materials may be used in combination. Among these organic materials, polyethylene terephthalate (PET) and polypropylene (PP) are preferable in terms of flexibility. Particularly, in the case of applying heat to the thermosensitive recording layer through the transparent base material during printing, polyethylene terephthalate (PET) excellent in heat resistance is more preferable. Using polyethylene terephthalate (PET), it is possible to obtain a thermosensitive recording medium excellent in head matchability.

A heat-resistant layer may be formed over the transparent base material, using, for example, a cured resin obtained by curing at least one, or two or more in combination, of monomers, oligomers, and polymers including, for example, water-soluble resins such as polyvinyl alcohols and modified polyvinyl alcohols, water-dispersible resins such as an acrylic emulsion, acrylates, methacrylates, vinyl esters, styrene derivatives, silicone resins, and aryl compounds.

As the modified polyvinyl alcohols, for example, carboxy-modified polyvinyl alcohols such as itaconic acid-modified polyvinyl alcohols, sulfonic acid-modified polyvinyl alcohols, silicone-modified polyvinyl alcohols, and other modified-polyvinyl alcohols may be appropriately used.

As a filler, the heat-resistant layer may contain an inorganic pigment such as calcium carbonate, silica, aluminum hydroxide, zinc oxide, titanium oxide, zinc hydroxide, barium sulfate, clay, kaolin, talc, and surface-treated calcium, and surface-treated silica, or an organic powder such as acrylic resins, urea-formalin resins, styrene-methacrylic acid copolymers, polystyrene resins, and vinylidene chloride resins. Further, as a cross-linking agent for, for example, the polyvinyl alcohols and the modified polyvinyl alcohols, the heat-resistant layer may contain glyoxal derivatives, methylol derivatives, epichlorohydrin derivatives, epoxy compounds, aziridine compounds, hydrazine, and hydrazide derivatives. Among these materials, combinations of modified polyvinyl alcohols and polyamide resins with inorganic pigments such as calcium carbonate and aluminum hydroxide are preferable.

The heat-resistant layer may further contain an ultraviolet absorber.

By providing the heat-resistant layer, it is possible to improve head matchability and printability. The thickness of the heat-resistant layer is preferably 0.1 micrometers or greater but 1.5 micrometers or less.

The transparent base material may appropriately contain an ultraviolet absorber such as a benzotriazole-based compound, a triazine-based compound, a benzophenone-based compound, and a hindered amine-based compound, and other additives. One of these additives may be used alone or two or more of these additives may be used in combination.

The shape of the transparent base material is not particularly limited and may be appropriately selected depending on the intended purpose. Examples of the shape of the transparent base material include polygons such as squares and rectangles, circles, ellipses, flat plate shapes, sheet shapes, and roll shapes.

The average thickness of the transparent base material may be appropriately selected depending on, for example, usages and materials of the thermosensitive recording medium. When the plastic film is used as the transparent base material, the average thickness of the transparent base material is preferably 4 micrometers or greater but 25 micrometers or less, more preferably from 6 micrometers or greater but 20 micrometers or less, and yet more preferably from 10 micrometers or greater but 16 micrometers or less. When the average thickness of the transparent base material is 4 micrometers or greater but 25 micrometers or less, the thermosensitive recording medium can be produced in a state that a good handleability is maintained, and heat from a printing head can be appropriately conducted to the thermosensitive recording layer during printing.

In order to improve adhesiveness of the thermosensitive recording layer with the transparent base material, it is preferable to subject the transparent base material to surface reformation by, for example, corona discharge treatment, oxidation reaction treatment (e.g., chromic acid), etching treatment, treatment for imparting easy adhesiveness, and antistatic treatment. Further, examples of a method for improving adhesiveness of the thermosensitive recording layer other than these surface reformation methods include a method of forming a layer (easily adhesive layer) containing a styrene-butadiene copolymer, or an acrylic-based aqueous emulsion or urethane-based aqueous emulsion alone, or a copolymer or a mixture of an acrylic-based aqueous emulsion with an urethane-based aqueous emulsion over the transparent base material, and then forming the thermosensitive recording layer over the easily adhesive layer. By providing the easily adhesive layer, it is possible to prevent peeling of the film.

<Thermosensitive recording layer>

The thermosensitive recording layer contains a leuco dye, a developer, and a binder resin, and further contains other components as needed.
Leuco dye

The leuco dye is not particularly limited and may be appropriately selected depending on the intended purpose. Examples of the leuco dye include leuco compounds for, for example, triphenylmethane-based, fluoran-based, phenothiazine-based, auramine-based, spiropyran-based, and indolinophthalide-based dyes. One of these leuco dyes may be used alone or two or more of these leuco dyes may be used in combination.

Examples of the leuco compounds include 3,3-bis(p-dimethylaminophenyl)-phthalide, 3,3-bis(p-dimethylaminophenyl)-6-dimethylaminophthalide (also known as crystal violet lactone), 3,3-bis(p-dimethylaminophenyl)-6-diethylaminophthalide, 3,3-bis(p-dimethylaminophenyl)-6-chlorophthalide, 3,3-bis(p-dibutylaminophenyl)phthalide, 3-cyclohexylamino-6-chlorofluoran, 3-dimethylamino-5,7-dimethylfluoran, 3-diethylamino-7-chlorofluoran, 3-diethylamino-7-methylfluoran, 3-diethylamino-7,8-benzfluoran, 3-diethylamino-6-methyl-7-chlorofluoran, 3-(N-p-tolyl-N-ethylamino)-6-methyl-7-anilinofluoran, 2-{N-(3′-trifluoromethylphenyl)amino}-6-diethylaminofluoran, 2-{3,6-bis(diethylamino)-9-(o-chloroanilino)xanthyl lactam benzoate}, 3-diethylamino-6-methyl-7-(m-trichloromethylanilino)fluoran, 3-diethylamino-7-(o-chloroanilino)fluoran, 3-pyrrolidino-6-methyl-7-anilinofluoran, 3-di-n-butylamino-7-o-chloroanilino)fluoran, 3-N-methyl-N,n-amylamino-6-methyl-7-anilinofluoran, 3-N-methyl-N-cyclohexylamino-6-methyl-7-anilinofluoran, 3-diethylamino-6-methyl-7-anilinofluoran, 3-(N,N-diethylamino)-5-methyl-7-(N,N-dibenzylamino)fluoran, benzoyl leuco methylene blue, 6′-chloro-8′-methoxy-benzoindolino-spiropyran, 6′-bromo-3′-methoxy-benzoindolino-spiropyran, 3-(2′-hydroxy-4′-dimethylaminophenyl)-3-(2′-methoxy-5′ chlorophenyl)phthalide, 3-(2′-hydroxy-4′-dimethylaminophenyl)-3-(2′-methoxy-5′-nitrophenyl)phthalide, 3-(2′-hydroxy-4′-diethylaminophenyl)-3-(2′-methoxy-5′-methylphenyl)phthalide, 3-(2′-methoxy-4′-dimethylaminophenyl)-3-(2′-hydroxy-4′-chloro-5′-methylphenyl)phth alide, 3-(N-ethyl-N-tetrahydrofurfuryl)amino-6-methyl-7-anilinofluoran, 3-N-ethyl-N-(2-ethoxypropyl)amino-6-methyl-7-anilinofluoran, 3-N-methyl-N-isobutyl-6-methyl-7-anilinofluoran, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorophenyl)methylaminofluoran, 3-diethylamino-5-chloro-7-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-n-butylanilino)fluoran, 3-di-n-butylamino-6-methyl-7-anilinofluoran, 3,6-bis(dimethylamino)fluorenespiro(9,3′)-6′-dimethylaminophthalide, 3-(N-benzyl-N-cyclohexylamino)-5,6-benzo-7-α-naphthylamino-4′-bromofluoran, 3-diethylamino-6-chloro-7-anilinofluoran, 3-diethylamino-6-methyl-7-mesitidino-4′,5′-benzofluoran, 3-N-methyl-N-isopropyl-6-methyl-7-anilinofluoran, 3-N-ethyl-N-isoamyl-6-methyl-7-anilinofluoran, 3-diethylamino-6-methyl-7-(2′,4′-dimethylanilino)fluoran, 3-diethylamino-5-chloro-(α-phenylethylamino)fluoran, 3-diethylamino-7-piperidinofluoran, 3-(N-benzyl-N-cyclohexylamino)-5,6-benzo-7-α-naphthylamino-4′-bromofluoran, 3-N-ethyl-N-tetrahydrofurfurylamino-6-methyl-7-anilinofluoran, 3-p-dimethylaminophenyl)-3-{1,1-bis(p-dimethylaminophenyl)ethylen-2-yl}phthalide, 3-(p-dimethylaminophenyl)-3-{1,1-bis(p-dimethylaminophenyl)ethylen-2-yl}-6-dimethylaminophthalide, 3-(p-dimethylaminophenyl)-3-(1-p-dimethylaminophenyl-1-phenylethylen-2-yl)phthalide, 3-(p-dimethylaminophenyl)-3-(1-p-dimethylaminophenyl-1-p-chlorophenylethylen-2-yl)-6-dimethylaminophthalide, 3-(4′-dimethylamino-2′-methoxy)-3-(1″-p-dimethylaminophenyl-1″-p-chlorophenyl-1″, 3″-butadien-4″-yl)benzophthalide, 3-(4′-dimethylamino-2′-benzyloxy)-3-(1″-p-dimethylaminophenyl-1″-phenyl-1″,3″-butadien-4″-yl)benzophthalide, 3-dimethylamino-6-dimethylamino-fluorene-9-spiro-3′-(6′-dimethylamino)phthalide, 3,3-bis(2-(p-dimethylaminophenyl)-2-p-methoxyphenyl)ethenyl)-4,5,6,7-tetrachloroph thalide, 3-bis{1,1-bis(4-pyrrolidinophenyl)ethylen-2-yl}-5,6-dichloro-4,7-dibromophthalide, bis(p-dimethylaminostyryl)-1-naphthalenesulfonylmethane, and bis(p-dimethylaminostyryl)-1-p-tolylsulfonylmethane.

The 50% cumulative volume particle diameter (D₅₀) of the leuco dye is preferably 0.1 micrometers or greater but 0.5 micrometers or less and more preferably 0.1 micrometers or greater but 0.4 micrometers or less.

The method for measuring the 50% cumulative volume particle diameter (D₅₀) of the leuco dye is not particularly limited and may be appropriately selected depending on the intended purpose. Examples of the method include a laser diffraction/scattering particle diameter distribution measuring instrument (instrument name: LA-920, available from Horiba, Ltd.).

The content of the leuco dye is not particularly limited, may be appropriately selected depending on the intended purpose, and is preferably 5 parts by mass or greater but 40 parts by mass or less and more preferably 10 parts by mass or greater but 30 parts by mass or less when the total amount of the thermosensitive recording layer is 100 parts by mass.
Developer

As the developer, various electron-accepting substances that react with the leuco dye when the leuco dye is heated and make the leuco dye develop a color can be used.

The developer is not particularly limited and may be appropriately selected depending on the intended purpose. Examples of the developer include phenolic substances, organic acidic substances, inorganic acidic substances, and esters or salts of these substances.

Examples of the developer include gallic acid, salicylic acid, 3-isopropylsalicylic acid, 3-cyclohexylsalicylic acid, 3,5-di-tert-butylsalicylic acid, 3,5-di-α-methylbenzylsalicylic acid, 4,4′-isopropylidenediphenol, 1,1′-isopropylidene bis(2-chlorophenol), 4,4′-isopropylidene bis(2,6-dibromophenol), 4,4′-isopropylidene bis(2,6-dichlorophenol), 4,4′-isopropylidene bis(2-methylphenol), 4,4′-isopropylidene bis(2,6-dimethylphenol), 4,4-isopropylidene bis(2-tert-butylphenol), 4,4′-sec-butylidene diphenol, 4,4′-cyclohexylidene bisphenol, 4,4′-cyclohexylidene bis(2-methylphenol), 4-tert-butylphenol, 4-phenylphenol, 4-hydroxy diphenoxide, α-naphthol, β-naphthol, 3,5-xylenol, thymol, methyl-4-hydroxybenzoate, 4-hydroxyacetophenone, novolac-type phenol resin, 2,2′-thiobis(4,6-dichlorophenol), catechol, resorcin, hydroquinone, pyrogallol, phloroglucinol, phloroglucinol carboxylic acid, 4-tert-octylcatechol, 2,2′-methylenebis(4-chlorophenol), 2,2′-methylenebis(4-methyl-6-tert-butylphenol), 2,2,-dihydroxydiphenyl, 2,4′-dihydroxydiphenyl sulfone, 4,4′-[oxybis(ethyleneoxy-P-phenylenesulfonyl)]diphenol, ethyl p-hydroxybenzoate, propyl p-hydroxybenzoate, butyl p-hydroxybenzoate, benzyl p-hydroxybenzoate, p-hydroxybenzoic acid-p-chlorobenzyl, p-hydroxybenzoic acid-o-chlorobenzyl, p-hydroxybenzoic acid-p-methylbenzyl, p-hydroxybenzoic acid-n-octyl, benzoic acid, zinc salicylate, 1-hydroxy-2-naphthoic acid, 2-hydroxy-6-naphthoic acid, zinc 2-hydroxy-6-naphthoate, 4-hydroxydiphenyl sulfone, 4-hydroxy-4′-chlorodiphenyl sulfone, bis(4-hydroxyphenyl)sulfide, 2-hydroxy-p-toluic acid, zinc 3,5-di-tert-butyl salicylate, tin 3,5-di-tert-butyl salicylate, tartaric acid, oxalic acid, maleic acid, citric acid, succinic acid, stearic acid, 4-hydroxyphthalic acid, boric acid, thiourea derivative, 4-hydroxythiophenol derivative, bis(4-hydroxyphenyl)acetic acid, ethyl bis(4-hydroxyphenyl)acetate, n-propyl bis(4-hydroxyphenyl)acetate, m-butyl bis(4-hydroxyphenyl)acetate, phenyl bis(4-hydroxyphenyl)acetate, benzyl bis(4-hydroxyphenyl)acetate, phenethyl bis(4-hydroxyphenyl)acetate, bis(3-methyl-4-hydroxyphenyl)acetic acid, methyl bis(3-methyl-4-hydroxyphenyl)acetate, n-propyl bis(3-methyl-4-hydroxyphenyl)acetate, 1,7-bis(4-hydroxyphenylthio)3,5-dioxaheptane, 1,5-bis(4-hydroxyphenylthio)3-oxaheptane, dimethyl 4-hydroxyphthalate, 4-hydroxy-4′-methoxydiphenylsulfone, 4-hydroxy-4′-ethoxydiphenylsulfone, 4-hydroxy-4′-isopropoxydiphenylsulfone, 4-hydroxy-4′-propoxydiphenylsulfone, 4,4′-bis(3-(phenoxycarbonylamino)methylphenylureido)diphenylsulfone, 4-hydroxy-4′-butoxydiphenylsulfone, 4-hydroxy-4′-isobutoxydiphenylsulfone, 4-hydroxy-4-butoxydiphenylsulfone, 4-hydroxy-4′-tert-butoxydiphenylsulfone, 4-hydroxy-4′-benzyloxydiphenylsulfone, 4-hydroxy-4′-phenoxydiphenylsulfone, 4-hydroxy-4′-(m-methylbenzyloxy)diphenylsulfone, 4-hydroxy-4′-(p-methylbenzyloxy)diphenylsulfone, 4-hydroxy-4′-(O-methylbenzyloxy)diphenylsulfone, 4-hydroxy-4′-(p-chlorobenzyloxy)diphenylsulfone, and N-(2-(3-phenylureido)phenyl)benzenesulfonamide. One of these developers may be used alone or two or more of these developers may be used in combination.

The 50% cumulative volume particle diameter (D₅₀) of the developer is preferably 0.1 micrometers or greater but 0.5 micrometers or less and more preferably 0.1 micrometers or greater but 0.4 micrometers or less.

The method for measuring the 50% cumulative volume particle diameter (D₅₀) of the developer is not particularly limited and may be appropriately selected depending on the intended purpose. Examples of the method include a laser diffraction/scattering particle diameter distribution measuring instrument (instrument name: LA-920, available from Horiba, Ltd.).

The content of the developer is not particularly limited, may be appropriately selected depending on the intended purpose, and is preferably 0.05 parts by mass or greater but 10 parts by mass or less and more preferably 1 part by mass or greater but 5 parts by mass or less relative to 1 part by mass of the leuco dye.
Binder resin

The binder resin is not particularly limited and may be appropriately selected depending on the intended purpose. Examples of the binder resin include: polyvinyl alcohol resins, starch or derivatives of starch; cellulose derivatives such as hydroxymethyl cellulose, hydroxyethyl cellulose, carboxymethyl cellulose, methyl cellulose, and ethyl cellulose; water-soluble polymers such as sodium polyacrylate, polyvinyl pyrrolidone, acrylamide-acrylic acid ester copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes of, for example, styrene-butadiene copolymers and styrene-butadiene-acrylic copolymers. One of these binder resins may be used alone or two or more of these binder resins may be used in combination. Among these binder resins, polyvinyl alcohol resins are preferable in terms of transparency and binding with a base material.
Other components

The other components are not particularly limited and may be appropriately selected depending on the intended purpose. Examples of the other components include various thermally fusible substances as sensitivity improvers, an auxiliary additive, a surfactant, a lubricant, a loading material, an ultraviolet absorber, and a coloring pigment.
Thermally fusible substance

Examples of the thermally fusible substance include: fatty acids such as stearic acid and behenic acid; fatty acid amides such as stearic acid amide and palmitic acid amide; fatty acid metal salts such as zinc stearate, aluminum stearate, calcium stearate, zinc palmitate, and zinc behenate; and p-benzyl biphenyl, terphenyl, triphenylmethane, benzyl p-benzyloxybenzoate, β-benzyloxynaphthalene, phenyl β-naphthoate, phenyl 1-hydroxy-2-naphthoate, methyl 1-hydroxy-2-naphthoate, diphenyl carbonate, glycol carbonate, dibenzyl terephthalate, dimethyl terephthalate, 1,4-dimethoxynaphthalene, 1,4-diethoxynaphthalene, 1,4-dibenzyloxynaphthalene, 1,2-diphenoxyethane, 1,2-bis(3-methylphenoxy)ethane, 1,2-bis(4-methylphenoxy)ethane, 1,4-diphenoxy-2-butene, 1,2-bis(4-methoxyphenylthio)ethane, dibenzoylmethane, 1,4-diphenylthiobutane, 1,4-diphenylthio-2-butene, 1,3-bis(2-vinyloxyethoxy)benzene, 1,4-bis(2-vinyloxyethoxy)benzene, p-(2-vinyloxyethoxy)biphenyl, p-aryloxybiphenyl, p-propargyloxybiphenyl, dibenzoyloxymethane, dibenzoyloxypropane, dibenzyl disulfide, 1,1-diphenyl ethanol, 1,1-diphenylpropanol, p-benzyloxy benzylalcohol, 1,3-phenoxy-2-propanol, N-octadecylcarbamoyl-p-methoxycarbonyl benzene, N-octadecylcarbamoyl benzene, 1,2-bis(4-methoxyphenoxy)propane, 1,5-bis(4-methoxyphenoxy)-3-oxapentane, dibenzyl oxalate, bis(4-methylbenzyl) oxalate, and bis(4-chlorobenzyl) oxalate. One of these thermally fusible substances may be used alone or two or more of these thermally fusible substances may be used in combination.
Auxiliary additive

The auxiliary additive is not particularly limited and may be appropriately selected depending on the intended purpose. Examples of the auxiliary additive include hindered phenol compounds and hindered amine compounds. One of these auxiliary additives may be used alone or two or more of these auxiliary additives may be used in combination.

Examples of the auxiliary additive include 2,2′-methylenebis(4-ethyl-6-tertiary butylphenol), 4,4′-butylidene bis(6-tertiary butyl-2-methylphenol), 1,1,3-tris(2-methyl-4-hydroxy-5-tertiary butylphenyl)butane, 1,1,3-tris(2-methyl-4-hydroxy-5-cyclohexylphenyl)butane, 4,4′-thiobis(6-tertiary butyl-2-methylphenol), tetrabromo bisphenol A, tetrabromo bisphenol S, 4,4-thiobis(2-methylphenol), 4,4′-thiobis(2-chlorophenol), tetrakis(1,2,2,6,6-pentamethyl-4-piperidyl)-1,2,3,4-butane tetracarboxylate, and tetrakis(1,2,2,6,6-tetramethyl-4-piperidyl)-1,2,3,4-butane tetracarboxylate. One of these auxiliary additives may be used alone or two or more of these auxiliary additives may be used in combination.
Surfactant

The surfactant is not particularly limited and may be appropriately selected depending on the intended purpose. Examples of the surfactant include anionic surfactants, nonionic surfactants, amphoteric surfactants, and fluorosurfactants. One of these surfactants may be used alone or two or more of these surfactants may be used in combination.

Examples of the anionic surfactant include polyoxyethylene alkyl ether acetate, dodecylbenzene sulfonate, laurate, and polyoxyethylene alkyl ether sulfate salt. One of these anionic surfactants may be used alone or two or more of these anionic surfactants may be used in combination.

Examples of the nonionic surfactant include acetylene glycol-based surfactants, polyoxyethylene alkyl ether, polyoxyethylene alkyl phenyl ether, polyoxyethylene alkyl ester, and polyoxyethylene sorbitan fatty acid ester. One of these nonionic surfactants may be used alone or two or more of these nonionic surfactants may be used in combination.

Examples of the acetylene glycol-based surfactant include 2,4,7,9-tetramethyl-5-decyne-4,7-diol, 3,6-dimethyl-4-octyne-3,6-diol, 3,5-dimethyl-1-hexyne-3-diol, and 2,5,8,11-tetramethyl-6-dodecyne-5,8-diol. One of these acetylene glycol-based surfactants may be used alone or two or more of these acetylene glycol-based surfactants may be used in combination.
Lubricant

The lubricant is not particularly limited and may be appropriately selected depending on the intended purpose. Examples of the lubricant include higher fatty acids or metal salts of higher fatty acids, higher fatty acid amides, higher fatty acid esters, animal waxes, vegetable waxes, mineral waxes, and petroleum waxes. One of these lubricants may be used alone or two or more of these lubricants may be used in combination.
Loading material

Examples of the loading material include: inorganic powders such as calcium carbonate, silica, zinc oxide, titanium oxide, zirconium oxide, aluminum hydroxide, zinc hydroxide, barium sulfate, clay, kaolin, talc, surface-treated calcium, and surface-treated silica; and organic powders such as urea-formalin resins, styrene-methacrylic acid copolymers, polystyrene resins, and vinylidene chloride resins. One of these loading materials may be used alone or two or more of these loading materials may be used in combination.

The content of the loading material is not particularly limited, may be appropriately selected depending on the intended purpose, and is preferably 0.5 parts by mass or greater but 5.0 parts by mass or less and more preferably 1.0 part by mass or greater but 4.0 parts by mass or less relative to 1 part by mass of the binder resin.
Ultraviolet absorber

The ultraviolet absorber is not particularly limited and may be appropriately selected depending on the intended purpose. Examples of the ultraviolet absorber include salicylic acid-based ultraviolet absorbers, benzophenone-based ultraviolet absorbers, and benzotriazole-based ultraviolet absorbers.

Examples of the ultraviolet absorber include phenyl salicylate, p-tert-butylphenyl salicylate, p-octylphenyl salicylate, 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-dimethoxybenzophenone, 2-hydroxy-4-methoxy-5-sulfobenzophenone, bis(2-methoxy-4-hydroxy-5-benzoylphenyl)methane, 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-3′,5′-di-tert-butylphenyl)chlorobenzotriazole, 2-(2′-hydroxy-3′-tert-butyl-5′-methylphenyl)-5-chlorobenzotriazole, 2-(2′-hydroxy-3′,5′-di-tert-amylphenyl)benzotriazole, 2-{2′-hydroxy-3′-(3″,4″,5″,6″-tetrahydrophthalimidemethyl)-5′-methylphenyl}benzotria zole, 2,2′-methylenebis {4-(1,1,3,3-tetramethylbutyl)-6-(2H-benzotriazol-2-yl)phenol}, 2-(2′-hydroxy-5′-methacryloxyphenyl)-2H-benzotriazole, 2-(3,5-di-t-amyl-2-hydroxyphenyl)benzotriazole, 2-(2′-hydroxy-5′-t-octylphenyl)benzotriazole, and 2-(5-methyl-2-hydroxyphenyl)benzotriazole. One of these ultraviolet absorbers may be used alone or two or more of these ultraviolet absorbers may be used in combination.
Coloring pigment

The coloring pigment is not particularly limited and may be appropriately selected depending on the intended purpose. Examples of the coloring pigment include chrome yellow, iron oxide pigments, molybdate orange, cadmium red, zinc sulfide compounds, Hansa yellow, Hansa orange, rose red, pyrazolone red, linoleic red, copper ph-thalocyanine blue, kopal polybromophthalocyanine blue, indanthrene blue, isodiben-zathrene violet, and anthanthrene orange. One of these coloring pigments may be used alone or two or more of these coloring pigments may be used in combination.

The method for forming the thermosensitive recording layer is not particularly limited and may be appropriately selected depending on the intended purpose. Examples of the method for forming the thermosensitive recording layer include a method of pulverizing and dispersing the leuco dye and the developer together with the binder resin using a disperser such as a ball mill, an attritor, and a sand mill, further mixing the resultant with, for example, the other components as needed to prepare a thermosensitive recording layer coating liquid, coating the thermosensitive recording layer coating liquid over the transparent base material, and then drying the thermosensitive recording layer coating liquid.

The coating method is not particularly limited and may be appropriately selected depending on the intended purpose. Examples of the coating method include a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a 4-roll or 5-roll coating method, a dip coating method, a curtain coating method, a slide coating method, and a die coating method.

The 50% cumulative volume particle diameter (D₅₀) of particles contained in the thermosensitive recording layer coating liquid is preferably 0.10 micrometers or greater but 3 micrometers or less, more preferably 0.10 micrometers or greater but 0.50 micrometers or less, and particularly preferably 0.10 micrometers or greater but 0.40 micrometers or less.

Examples of the particles contained in the thermosensitive recording layer coating liquid include a dye, a developer, a filler, and a coloring pigment.

The amount of the thermosensitive recording layer remaining attached after drying is not particularly limited, may be appropriately selected depending on the intended purpose, and is preferably, for example, 1.0 g/m² or greater but 20.0 g/m² or less, more preferably 2.0 g/m² or greater but 10.0 g/m² or less, and particularly preferably 2.0 g/m² or greater but 4.0 g/m² or less.

<Barrier layer>

The barrier layer is a layer provided over a surface of the thermosensitive recording layer opposite to the surface of the thermosensitive recording layer facing the transparent base material. The barrier layer contains hollow particles and a binder resin and further contains other components as needed. By providing the barrier layer, it is possible to suppress degradation of the thermosensitive recording layer due to the components contained in any other layer and improve temporal color fade resistance. It is also possible to prevent migration of a tackifier from a tackifier layer.
Hollow particles

The hollow particles are particles filled with air or any other gas within a shell formed of a thermoplastic resin. Examples of the thermoplastic resin constituting the shell of the hollow particles include polystyrene resins, polyvinyl chloride resins, polyvinylidene chloride resins, polyvinyl acetate resins, polyacrylic acid ester resins, polyacrylonitrile resins, and polybutadiene resins or copolymers of these thermoplastic resins. Copolymers mainly formed of vinylidene chloride and acrylonitrile among these thermoplastic resins are particularly preferable.

The rate of hollowness of the hollow particles is preferably 45% or higher and more preferably 80% or higher. When the rate of hollowness of the hollow particles is 45% or higher, color developing sensitivity can be improved.

The rate of hollowness refers to a ratio between the volume of a hollow particle and the hollow portion, and is expressed by a percentage (%). The hollow particles can be regarded as almost a spherical shape. Therefore, the rate of hollowness is represented by the formula below.

Rate of hollowness (%)=[(volume of hollow portion)/(volume of hollow particle)]×100

The volume average particle diameter (particle outer diameter) of the hollow particles is preferably 0.4 micrometers or greater but 10 micrometers or less. When the volume average particle diameter (particle outer diameter) of the hollow particles is 0.4 micrometers or greater but 10 micrometers or less, color developing sensitivity can be improved.

The content of the hollow particles is preferably 35% by mass or greater but 80% by mass or less relative to the binder resin.
Binder resin

The binder resin is not particularly limited and may be appropriately selected depending on the intended purpose. Examples of the binder resin include: polyvinyl alcohol resins, starch or derivatives of starch; cellulose derivatives such as hydroxymethyl cellulose, hydroxyethyl cellulose, carboxymethyl cellulose, methyl cellulose, and ethyl cellulose; water-soluble polymers such as sodium polyacrylate, polyvinyl pyrrolidone, acrylamide-acrylic acid ester copolymers, acrylamide-acrylic acid ester-methacrylic acid terpolymers, styrene-maleic anhydride copolymer alkali salts, isobutylene-maleic anhydride copolymer alkali salts, polyacrylamide, sodium alginate, gelatin, and casein; emulsions of, for example, polyvinyl acetate, polyurethane, polyacrylic acid, polyacrylic acid ester, vinyl chloride-vinyl acetate copolymers, polybutyl methacrylate, and ethylene-vinyl acetate copolymers; and latexes (aqueous emulsions) of, for example, styrene-butadiene copolymers and styrene-butadiene-acrylic copolymers. One of these binder resins may be used alone or two or more of these binder resins may be used in combination. Among these binder resins, it is preferable to use styrene-butadiene copolymers in terms of bindability with the thermosensitive recording layer and a barrier function.
Other components

The other components are not particularly limited and may be appropriately selected depending on the intended purpose. The same components as the components applicable to the thermosensitive recording layer can be used.

The amount of the barrier layer remaining attached after drying is not particularly limited, may be appropriately selected depending on the intended purpose, and is preferably 0.5 g/m² or greater but 10.0 g/m² or less, more preferably 1.0 g/m² or greater but 8.0 g/m² or less, and particularly preferably 3.0 g/m² or greater but 6.0 g/m² or less.

<Other layers>

The other layers are not particularly limited and may be appropriately selected depending on the intended purpose. Examples of the other layers include a tackifier layer.
Tackifier layer

It is preferable to provide the tackifier layer over a surface of the barrier layer opposite to the surface of the barrier layer on the thermosensitive recording layer side.

The tackifier that can be used in the tackifier layer is not particularly limited and may be appropriately selected depending on the intended purpose. Examples of the tackifier include a pressure-sensitive tackifier and other types of tackifiers.

Examples of the tackifier include urea resins, melamine resins, phenol resins, epoxy resins, vinyl acetate-based resins, vinyl acetate-acrylic-based copolymers, ethylene-vinyl acetate copolymers, acrylic-based resins, polyvinyl ether-based resins, vinyl chloride-vinyl acetate-based copolymers, polystyrene-based resins, polyester-based resins, polyurethane-based resins, polyamide-based resins, chlorinated polyolefin-based resins, polyvinyl butyral-based resins, acrylic acid ester-based copolymers, methacrylic acid ester-based copolymers, natural rubbers, cyano acrylate-based resins, and silicone-based resins. One of these materials may be used alone or two or more of these materials may be used in combination.

These materials may be cross-linked by means of a cross-linking agent. The material of the tackifier layer may be a hot-melt type.

The thickness of the tackifier layer is not particularly limited, may be appropriately selected depending on the intended purpose, and is preferably 0.1 micrometers or greater but 20 micrometers or less.

The mode of the thermosensitive recording medium of the present disclosure is not particularly limited and may be appropriately selected depending on the intended purpose. For example, with release paper pasted over the tackifier layer, the thermosensitive recording medium may be used as a sticker-type thermosensitive recording medium or a thermosensitive recording label.

The release paper is not particularly limited and may be appropriately selected depending on the intended purpose. Examples of the release paper include release paper obtained by pasting neutral paper, acid paper, or plastics. Moreover, stereotyped illustrations such as colored logos or fixed phrases may be printed by a printing method such as inkjet or offset over a side of the transparent base material opposite to the side on which the thermosensitive recording layer is formed.

The shape of the thermosensitive recording medium of the present disclosure is not particularly limited and may be appropriately selected depending on the intended purpose. Examples of the shape of the thermosensitive recording medium include a label shape, a sheet shape, and a roll shape. Furthermore, the thermosensitive recording medium may be a linerless type wound in a roll shape with a release layer formed over the transparent base material.

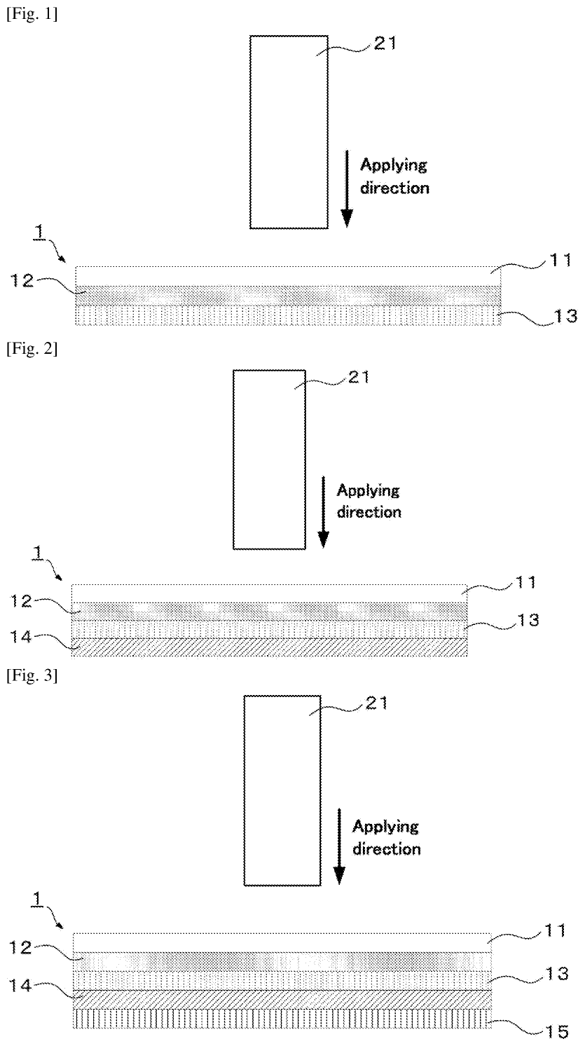

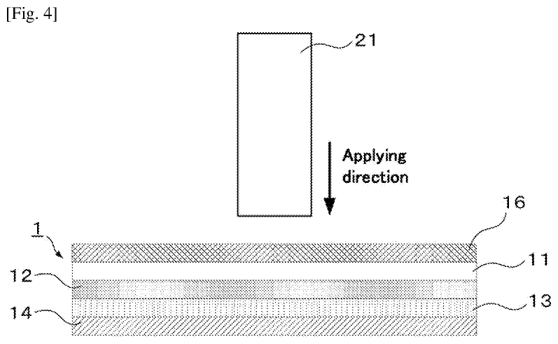

FIG. 1 is a view illustrating an example of the thermosensitive recording medium of the present disclosure. As illustrated in FIG. 1, a thermosensitive recording medium 1 of the present disclosure includes a thermosensitive recording layer 12 and a barrier layer 13 in this order over a transparent base material 11. When thermal energy is applied by a heat source 21 to the thermosensitive recording layer 12 from a surface of the thermosensitive recording medium 1 of the present disclosure having the transparent base material 11, the thermosensitive recording layer 12 develops a color. As illustrated in FIG. 2, a tackifier layer 14 may be provided over the barrier layer 13. Further, as illustrated in FIG. 3, release paper 15 may be provided over the tackifier layer 14. Moreover, as illustrated in FIG. 4, it is possible to employ a layer configuration in which a release layer 16 is provided over the transparent base material 11.

(Thermosensitive Recording Medium Producing Method)

A thermosensitive recording medium producing method of the present disclosure includes a step of forming a thermosensitive recording layer over a transparent base material and a step of forming a barrier layer containing hollow particles and a binder resin over the thermosensitive recording layer, and further includes other steps as needed.

<Step of forming thermosensitive recording layer>

The step of forming a thermosensitive recording layer is not particularly limited and may be appropriately selected depending on the intended purpose. The same step as the step of the above-described method for forming the thermosensitive recording layer may be employed.

It is preferable to subject a surface of the transparent base material to be provided with a thermosensitive recording layer to surface reformation by, for example, corona discharge treatment, oxidation reaction treatment (e.g., chromic acid), etching treatment, treatment for imparting easy adhesiveness, and antistatic treatment, before coating a thermosensitive recording layer coating liquid over the surface. This makes it possible to improve adhesiveness between the transparent base material and the thermosensitive recording layer. In addition to these surface reformation methods, a layer (easily adhesive layer) containing, for example, a styrene-butadiene polymer may be formed over the transparent base material, and then the thermosensitive recording layer may be formed over the layer containing the styrene-butadiene polymer. This makes it possible to prevent peeling of the film.

<Step of forming barrier layer>

Next, a barrier layer coating liquid is coated over the thermosensitive recording layer to form a barrier layer. The step of forming a barrier layer is not particularly limited and may be appropriately selected depending on the intended purpose. Examples of the step include a step of dispersing hollow particles together with an aqueous solution containing a binder resin using a disperser, to prepare a barrier layer coating liquid, adding other materials to the resultant as needed, coating the barrier layer coating liquid over the thermosensitive recording layer, and subsequently drying the barrier layer coating liquid.

The method for coating the barrier layer coating liquid is not particularly limited and may be appropriately selected depending on the intended purpose. For example, the same method as the above-described method for coating the thermosensitive recording layer coating liquid may be employed.

<Step of forming tackifier layer>

It is optional whether to form a tackifier layer over the barrier layer. In the case of forming a tackifier layer, it is possible to form a tackifier layer by coating a tackifier over the barrier layer by a coating method such as a bar coating method, a roll coating method, a comma coating method, and a gravure coating method, and subsequently drying the tackifier.

<Other steps>

As the other steps, for example, in the case of producing a sticker-type thermosensitive recording medium, it is preferable to paste release paper over the tackifier layer. The method for pasting the release paper is not particularly limited, and a method used for general purposes may be used.

In the case of producing a linerless-type thermosensitive recording medium, a release layer coating liquid may be coated over a side of the transparent base material opposite to the side at which the thermosensitive recording layer is formed. As the method for coating the release layer coating liquid, the same method as the above-described method for coating the thermosensitive recording layer coating liquid may be used.

A method for recording information on the thermosensitive recording medium of the present disclosure is not particularly limited and may be appropriately selected depending on the intended purpose so long as the method can apply light or thermal energy to the thermosensitive recording layer through the surface of the thermosensitive recording layer having the transparent base material using a heat source. Examples of the heat source include a thermal head, a thermal stamp, a CO₂ laser, and a semiconductor laser.

Examples of the usage of the thermosensitive recording medium of the present disclosure include usages by being pasted or attached on articles that need to have a high solvent resistance, such as a solvent container. The material of the solvent container is not particularly limited, and examples of the material of the solvent container include metals, plastics, and glass. Usages of the thermosensitive recording medium on articles that need to have a high solvent resistance enable appropriate management of the articles without fade of, for example, characters even if solvents adhere to the thermosensitive recording medium.

(Article)

An article of the present disclosure includes the thermosensitive recording medium of the present disclosure.

As the thermosensitive recording medium, the thermosensitive recording medium of the present disclosure can be suitably used.

The state that the article includes the thermosensitive recording medium of the present disclosure refers to a state that the thermosensitive recording medium of the present disclosure is, for example, pasted or attached on the article.

The article of the present disclosure is not particularly limited and may be appropriately selected depending on the intended purpose so long as the article includes the thermosensitive recording medium of the present disclosure. Examples of the article include packing materials, packaging materials, and wrapping paper. Examples of the article to be particularly mentioned include an article that needs to have a high solvent resistance.

### EXAMPLES

The present disclosure will be described below by way of Examples. The present disclosure should not be construed as being limited to these Examples.

### Example 1

<Preparation of thermosensitive recording layer coating liquid C₁>

2-Anilino-3-methyl-6-butylaminofluoran (20 parts by mass) and a 10% by mass itaconic acid-modified polyvinyl alcohol aqueous solution (40 parts by mass) were subjected to dispersion treatment using a sand mill, to obtain <A liquid>, which was a dye dispersion liquid A₁.

Likewise, a polymerization product mainly formed of 4,4′-[oxybis(ethyleneoxy-P-phenylenesulfonyl)]diphenol (product name: D-90, available from Nippon Soda Co., Ltd.) (10 parts by mass), 2,4′-dihydroxydiphenylsulfone (product name: PBS-24, available from Nicca Chemical Co., Ltd.) (10 parts by mass), a 10% by mass itaconic acid-modified polyvinyl alcohol aqueous solution (30 parts by mass), and water (30 parts by mass) were subjected to dispersion treatment in the same manner as in preparation of <A liquid>, to obtain <B liquid>, which was a developer dispersion liquid B₁.

Next, the obtained dye dispersion liquid A₁ (20 parts by mass), the obtained developer dispersion liquid B₁ (80 parts by mass), a 10% by mass itaconic acid-modified polyvinyl alcohol aqueous solution (30 parts by mass), silica (1 part by mass), and water (45 parts by mass) were mixed and stirred, to obtain <C liquid>, which was a thermosensitive recording layer coating liquid C₁.

<Preparation of barrier layer coating liquid D₁>

Hollow resin particles (with a rate of hollowness of 30%) (25 parts by mass), a styrene-butadiene copolymer latex (15 parts by mass), and water (60 parts by mass) were stirred and dispersed, to obtain <D liquid>, which was a barrier layer coating liquid D₁.

Production of thermosensitive recording medium 1

The thermosensitive recording layer coating liquid C₁ and the barrier layer coating liquid D₁ were coated in this order over one side of a corona-treated polypropylene film serving as a transparent base material and having an average thickness of 12 micrometers such that the amounts of the liquids remaining attached after drying would be 5.0 g/m² both, and dried, to obtain a thermosensitive recording medium precursor 1.

Next, the thermosensitive recording medium precursor 1 was put in a high-density polyethylene bag, closely sealed, and cured in an environment of 40 degrees C. for 72 hours, to produce a thermosensitive recording medium 1.

### Example 2

A thermosensitive recording medium 2 was produced in the same manner as in Example 1, except that unlike in Example 1, an acrylic emulsion (available from Henkel Japan Ltd., AQUENCE PS AQ590 NACOR, with a solid component concentration of 54% by mass) serving as a pressure-sensitive tackifier was further coated over the barrier layer such that the amount of the acrylic emulsion remaining attached after drying would be 20 g/m², to form a tackifier layer.

### Example 3

A thermosensitive recording medium 3 was produced in the same manner as in Example 2, except that a polyethylene terephthalate film having an average thickness of 50 micrometers (product name: E5100, available from Toyobo Co., Ltd.) was further pressure-bonded over the tackifier layer of the thermosensitive recording medium 2 produced in Example 2, to form a support layer.

### Example 4

A thermosensitive recording medium 4 was produced in the same manner as in Example 2, except that unlike in Example 2, a barrier layer coating liquid D₂ was prepared using hollow resin particles having a rate of hollowness of 45%.

### Example 5

A thermosensitive recording medium 5 was produced in the same manner as in Example 2, except that unlike in Example 2, a barrier layer coating liquid D₃ was prepared using hollow resin particles having a rate of hollowness of 95%.

### Example 6

A thermosensitive recording medium 6 was produced in the same manner as in Example 2, except that unlike in Example 2, a barrier layer coating liquid D₄ was prepared using hollow resin particles having a rate of hollowness of 90%, and a corona-treated polyethylene terephthalate film having an average thickness of 1 micrometer (product name: E5100, available from Toyobo Co., Ltd.) was used instead of the polypropylene film having an average thickness of 12 micrometers.

### Example 7

A thermosensitive recording medium was produced in the same manner as in Example 6, except that unlike in Example 6, a corona-treated polyethylene terephthalate film having an average thickness of 4 micrometers (product name: LUMIRROR F57, available from Toray Industries, Inc.) was used instead of the polyethylene terephthalate film having an average thickness of 1 micrometer, to obtain a thermosensitive recording medium 7.

### Example 8

A thermosensitive recording medium was produced in the same manner as in Example 6, except that unlike in Example 6, a corona-treated polyethylene terephthalate film having an average thickness of 20 micrometers was used instead of the polyethylene terephthalate film having an average thickness of 1 micrometer, to obtain a thermosensitive recording medium 8.

### Example 9

A thermosensitive recording medium was produced in the same manner as in Example 6, except that unlike in Example 6, a corona-treated polyethylene terephthalate film having an average thickness of 25 micrometers (product name: E5100, available from Toyobo Co., Ltd.) was used instead of the polyethylene terephthalate film having an average thickness of 1 micrometer, to obtain a thermosensitive recording medium 9.

### Example 10

A thermosensitive recording medium was produced in the same manner as in Example 6, except that unlike in Example 6, a corona-treated polyethylene terephthalate film having an average thickness of 12 micrometers (product name: E5100, available from Toyobo Co., Ltd.) was used instead of the polyethylene terephthalate film having an average thickness of 1 micrometer, and the amount of the barrier layer remaining attached after drying was changed to 0.5 g/m², to obtain a thermosensitive recording medium 10.

### Example 11

A thermosensitive recording medium was produced in the same manner as in Example 10, except that unlike in Example 10, the amount of the barrier layer remaining attached after drying was changed to 1.0 g/m², to obtain a thermosensitive recording medium 11.

### Example 12

A thermosensitive recording medium was produced in the same manner as in Example 10, except that unlike in Example 10, the amount of the barrier layer remaining attached after drying was changed to 8.0 g/m², to obtain a thermosensitive recording medium 12.

### Example 13

A thermosensitive recording medium was produced in the same manner as in Example 10, except that unlike in Example 10, the amount of the barrier layer remaining attached after drying was changed to 10.0 g/m², to obtain a thermosensitive recording medium 13.

### Example 14

A thermosensitive recording medium was produced in the same manner as in Example 10, except that unlike in Example 10, the amount of the barrier layer remaining attached after drying was changed to 5.0 g/m², and <E liquid>, which was a heat-resistant layer coating liquid E₁ prepared according to the blend described below, was coated over a surface of the polyethylene terephthalate film opposite to the thermosensitive recording layer such that the amount of the liquid remaining attached after drying would be 0.5 g/m², to obtain a thermosensitive recording medium 14.

<Heat-resistant layer coating liquid E₁>
Silicone rubber (product name: SD7226, available from Dow Corning Toray Silicone Co., Ltd.): 10 parts by mass
Toluene: 50 parts by mass

### Example 15

A thermosensitive recording medium was produced in the same manner as in Example 14, except that unlike in Example 14, <E liquid>, which was a heat-resistant layer coating liquid E₂ prepared according to the procedure described below, was coated instead of <E liquid>, which was the heat-resistant layer coating liquid E₁ such that the amount of the liquid remaining attached after drying would be 0.5 g/m², to obtain a thermosensitive recording medium 15.

<Inorganic filler dispersion liquid F₁>

A liquid prepared according to the blend described below was subjected to dispersion treatment for 24 hours using a sand mill, to prepare <F liquid>, which was an inorganic filler dispersion liquid F₁.
Aluminum hydroxide (with an average particle diameter of 0.6 micrometers, product name: HYDIRITE H-43M, available from Showa Denko K.K.): 20 parts by mass −10% by mass itaconic acid-modified polyvinyl alcohol aqueous solution: 20 parts by mass
Water: 60 parts by mass

<Heat-resistant layer coating liquid E₂>

Next, a liquid according to the blend described below was mixed and stirred, to obtain <E liquid>, which was a heat-resistant layer coating liquid E₂.
<F liquid> inorganic filler dispersion liquid F₁: 25 parts by mass
10% by mass itaconic acid-modified polyvinyl alcohol aqueous solution: 50 parts by mass
25% by mass polyamide epichlorohydrin resin aqueous solution: 8 parts by mass
Water: 100 parts by mass

### Example 16

A thermosensitive recording medium was produced in the same manner as in Example 15, except that unlike in Example 15, a non-corona-treated polyethylene terephthalate film having an average thickness of 12 micrometers was used instead of the corona-treated polyethylene terephthalate film having an average thickness of 12 micrometers, to obtain a thermosensitive recording medium 16.

### Example 17

A thermosensitive recording medium was produced in the same manner as in Example 16, except that unlike in Example 16, an aqueous emulsion of a styrene-butadiene copolymer was coated between the polyethylene terephthalate film and the thermosensitive recording layer such that the amount of the aqueous emulsion remaining attached after drying would be 0.3 g/m² to provide an easily adhesive layer, to obtain a thermosensitive recording medium 17.

### Example 18

A thermosensitive recording medium was produced in the same manner as in Example 15, except that unlike in Example 15, <B liquid>, which was a developer dispersion liquid B₂ prepared according to the blend described below and subjected to dispersion treatment using a sand mill, was used instead of <B liquid>, which was the developer dispersion liquid B₁ to prepare a thermosensitive recording layer coating liquid C₂, to obtain a thermosensitive recording medium 18.

<Developer dispersion liquid B₂>
2,4′-dihydroxydiphenylsulfone (product name: BPS-24, available from Nicca Chemical Co., Ltd.): 20 parts by mass
10% by mass itaconic acid-modified polyvinyl alcohol aqueous solution: 30 parts by mass
Water: 30 parts by mass

### Example 19

A thermosensitive recording medium was produced in the same manner as in Example 15, except that unlike in Example 15, <B liquid>, which was a developer dispersion liquid B₃ prepared according to the blend described below and subjected to dispersion treatment using a sand mill, was used instead of <B liquid>, which was the developer dispersion liquid B₁ to prepare a thermosensitive recording layer coating liquid C₃, to obtain a thermosensitive recording medium 19.

<Developer dispersion liquid B₃>
4,4′-bis(3-(phenoxycarbonylamino)methylphenylureido)diphenyl sulfone (product name: UU, available from Asahi Kasei Corporation): 10 parts by mass
2,4′-dihydroxydiphenylsulfone (product name: BPS-24, available from Nicca Chemical Co., Ltd.): 10 parts by mass
10% by mass itaconic acid-modified polyvinyl alcohol aqueous solution: 30 parts by mass
Water: 30 parts by mass

### Example 20

A thermosensitive recording medium was produced in the same manner as in Example 15, except that unlike in Example 15, <C liquid>, which was a thermosensitive recording layer coating liquid C₄ prepared according to the blend described below, was used instead of <C liquid>, which was the thermosensitive recording layer coating liquid C₁, to obtain a thermosensitive recording medium 20.

<Thermosensitive recording layer coating liquid C₄>
Dye dispersion liquid A₁: 20 parts by mass
Developer dispersion liquid B₁: 80 parts by mass
2-(2′-hydroxy-3′-t-butyl-5′-methylphenyl)-5-chlorobenzotriazole (product name: SUMISORB 300, ultraviolet absorber, available from Sumitomo Chemical Co., Ltd.): 0.8 parts by mass
10% by mass itaconic acid-modified polyvinyl alcohol aqueous solution: 30 parts by mass
Silica: 1 part by mass
Water: 45 parts by mass

### Example 21

A thermosensitive recording medium was produced in the same manner as in Example 15, except that unlike in Example 15, <C liquid>, which was a thermosensitive recording layer coating liquid C₅ prepared according to the blend described below, was used instead of <C liquid>, which was the thermosensitive recording layer coating liquid C₁, to obtain a thermosensitive recording medium 21.

<Thermosensitive recording layer coating liquid C₅>
Dye dispersion liquid A₁: 20 parts by mass
Developer dispersion liquid B₁: 80 parts by mass
Yellow coloring pigment: 0.5 parts by mass
10% by mass itaconic acid-modified polyvinyl alcohol aqueous solution: 30 parts by mass
Silica: 1 part by mass
Water: 45 parts by mass

### Comparative Example 1

The barrier layer coating liquid D₄, the thermosensitive recording layer coating liquid C₁, and the heat-resistant layer coating liquid E₂ were sequentially laminated over the polyethylene terephthalate film having an average thickness of 50 micrometers and used as the support layer in Example 3, such that the amounts of the liquids remaining attached after drying would be 5.0 g/m², 5.0 g/m², and 1.5 g/m² respectively, to obtain a thermosensitive recording medium 22.

### Comparative Example 2

A thermosensitive recording medium was produced in the same manner as in Example 15, except that unlike in Example 15, a barrier layer was not provided, to obtain a thermosensitive recording medium 23.

### Comparative Example 3

A thermosensitive recording medium was produced in the same manner as in Example 15, except that unlike in Example 15, a barrier layer coating liquid D₅ according to the blend described below was used instead of the barrier layer coating liquid D₄, to obtain a thermosensitive recording medium 24.

<Barrier layer coating liquid D₅>
10% by mass itaconic acid-modified polyvinyl alcohol aqueous solution: 100 parts by mass
25% by mass polyamide epichlorohydrin resin aqueous solution: 16 parts by mass

### Comparative Example 4

A thermosensitive recording medium 25 was produced in the same manner as in Example 14, except that unlike in Example 14, a non-corona-treated polyethylene terephthalate film having an average thickness of 1.5 micrometers was used instead of the corona-treated polyethylene terephthalate film having an average thickness of 12 micrometers and a barrier layer was not provided.

### Comparative Example 5

A thermosensitive recording medium was produced in the same manner as in Example 15, except that unlike in Example 15, the average thickness of a corona-treated polyethylene terephthalate film was changed to 5 micrometers, a heat-resistant layer was not provided, and instead of the thermosensitive recording layer coating liquid C₁ and the barrier layer coating liquid D₄, a thermosensitive recording layer coating liquid C₆ and a barrier layer coating liquid D₆ prepared according to the procedures described below were coated such that the amounts of the liquids remaining attached after drying would be 10 g/m₂ for the thermosensitive recording layer and 0.5 g/m₂ for the barrier layer, to obtain a thermosensitive recording medium 26.

<Preparation of thermosensitive recording layer coating liquid C₆>

1,2-Benzo-6-diethylaminofluoran (10 parts by mass) and a 10% by mass polyvinyl alcohol aqueous solution (100 parts by mass) were subjected to dispersion treatment using a sand mill, to prepare <A liquid>, which was a dye dispersion liquid A₂.

Next, 2-oxotetradecanoic acid (20 parts by mass) and a 10% by mass polyvinyl alcohol aqueous solution (100 parts by mass) were subjected to dispersion treatment using a sand mill, to prepare <B liquid>, which was a developer dispersion liquid B₄.

The dye dispersion liquid A₂ (50 parts by mass) and the developer dispersion liquid B₄ (50 parts by mass) were mixed, to prepare a thermosensitive recording layer coating liquid C₆.

<Barrier layer coating liquid D₆>
Isocyanate resin (product name: CROSSNATE D-70, available from Dainichiseika Color & Chemicals Mfg. Co., Ltd.): 100 parts by mass

TABLE 1-1

| | | | | | | | | Barrier layer | | | |
|---|---|---|---|---|---|---|---|---|---|---|---|
| | | Transparent base | | | | | | | | | Amount |
| | | material | | Thermosensitive recording layer | | | | | | Rate of | remaining |
| | | | Thickness | Liquid | | Ultraviolet | Coloring | Liquid | | hollowness | attached |
| | | Kind | (micrometer) | No. | Developer | absorber | pigment | No. | Kind | (%) | (g/m²) |
| Ex. | 1 | PP | 12 | C₁ | D-90/ | — | — | D₁ | Hollow | 30 | 5 |
| | | | | | BPS-24 | | | | particles | | |
| | 2 | PP | 12 | C₁ | D-90/ | — | — | D₁ | Hollow | 30 | 5 |
| | | | | | BPS-24 | | | | particles | | |
| | 3 | PP | 12 | C₁ | D-90/ | — | — | D₁ | Hollow | 30 | 5 |
| | | | | | BPS-24 | | | | particles | | |
| | 4 | PP | 12 | C₁ | D-90/ | — | — | D₂ | Hollow | 45 | 5 |
| | | | | | BPS-24 | | | | particles | | |
| | 5 | PP | 12 | C₁ | D-90/ | — | — | D₃ | Hollow | 95 | 5 |
| | | | | | BPS-24 | | | | particles | | |
| | 6 | PET | 1 | C₁ | D-90/ | — | — | D₄ | Hollow | 90 | 5 |
| | | | | | BPS-24 | | | | particles | | |
| | 7 | PET | 4 | C₁ | D-90/ | — | — | D₄ | Hollow | 90 | 5 |
| | | | | | BPS-24 | | | | particles | | |
| | 8 | PET | 20 | C₁ | D-90/ | — | — | D₄ | Hollow | 90 | 5 |
| | | | | | BPS-24 | | | | particles | | |
| | 9 | PET | 25 | C₁ | D-90/ | — | — | D₄ | Hollow | 90 | 5 |
| | | | | | BPS-24 | | | | particles | | |
| | 10 | PET | 12 | C₁ | D-90/ | — | — | D₄ | Hollow | 90 | 0.5 |
| | | | | | BPS-24 | | | | particles | | |
| | 11 | PET | 12 | C₁ | D-90/ | — | — | D₄ | Hollow | 90 | 1 |
| | | | | | BPS-24 | | | | particles | | |
| | 12 | PET | 12 | C₁ | D-90/ | — | — | D₄ | Hollow | 90 | 8 |
| | | | | | BPS-24 | | | | particles | | |
| | 13 | PET | 12 | C₁ | D-90/ | — | — | D₄ | Hollow | 90 | 10 |
| | | | | | BPS-24 | | | | particles | | |
| | 14 | PET | 12 | C₁ | D-90/ | — | — | D₄ | Hollow | 90 | 5 |
| | | | | | BPS-24 | | | | particles | | |
| | 15 | PET | 12 | C₁ | D-90/ | — | — | D₄ | Hollow | 90 | 5 |
| | | | | | BPS-24 | | | | particles | | |
| | 16 | PET | 12 | C₁ | D-90/ | — | — | D₄ | Hollow | 90 | 5 |
| | | | | | BPS-24 | | | | particles | | |
| | 17 | PET | 12 | C₁ | D-90/ | — | — | D₄ | Hollow | 90 | 5 |
| | | | | | BPS-24 | | | | particles | | |
| | 18 | PET | 12 | C₂ | D-90/ | — | — | D₄ | Hollow | 90 | 5 |
| | | | | | BPS-24 | | | | particles | | |
| | 19 | PET | 12 | C₃ | UU/ | — | — | D₄ | Hollow | 90 | 5 |
| | | | | | BPS-40 | | | | particles | | |
| | 20 | PET | 12 | C₄ | D-90/ | Present | — | D₄ | Hollow | 90 | 5 |
| | | | | | BPS-24 | | | | particles | | |
| | 21 | PET | 12 | C₅ | D-90/ | — | Present | D₄ | Hollow | 90 | 5 |
| | | | | | BPS-24 | | | | particles | | |
| Comp. | 1 | — | — | C₁ | D-90/ | — | Present | D₄ | Hollow | 90 | 5 |
| Ex. | | | | | BPS-24 | | | | particles | | |
| | 2 | PET | 12 | C₄ | D-90/ | — | — | D₄ | — | — | — |
| | | | | | BPS-24 | | | | | | |
| | 3 | PET | 12 | C₄ | D-90/ | — | — | D₅ | Itaconic | — | 5 |
| | | | | | BPS-24 | | | | acid- | | |
| | | | | | | | | | modified | | |
| | | | | | | | | | PVA | | |
| | 4 | PET | 1.5 | C₁ | D-90/ | — | — | D₄ | — | — | — |
| | | | | | BPS-24 | | | | | | |
| | 5 | PET | 5 | C₆ | 2-oxotetra- | — | — | D₆ | Isocyanate | — | 0.5 |
| | | | | | decanoic | | | | resin | | |

TABLE 1-2

| | | | | | Means for |
|---|---|---|---|---|---|
| | | | | Heat- | imparting |
| | | Tackifier | Support | resistant | easy |
| | | layer | layer | layer | adhesiveness |
| Ex. | 1 | — | — | — | Corona |
| | 2 | Present | — | — | Corona |
| | 3 | Present | Present | — | Corona |
| | 4 | Present | — | — | Corona |
| | 5 | Present | — | — | Corona |
| | 6 | Present | — | — | Corona |
| | 7 | Present | — | — | Corona |
| | 8 | Present | — | — | Corona |
| | 9 | Present | — | — | Corona |
| | 10 | Present | — | — | Corona |
| | 11 | Present | — | — | Corona |
| | 12 | Present | — | — | Corona |
| | 13 | Present | — | — | Corona |
| | 14 | Present | — | Silicone | Corona |
| | | | | resin | |
| | 15 | Present | — | Aluminum | Corona |
| | | | | hydroxide | |
| | 16 | Present | — | Aluminum | — |
| | | | | hydroxide | |
| | 17 | Present | — | Aluminum | Easily |
| | | | | hydroxide | adhesive |
| | | | | | layer |
| | 18 | Present | — | Aluminum | Corona |
| | | | | hydroxide | |
| | 19 | Present | — | Aluminum | Corona |
| | | | | hydroxide | |
| | 20 | Present | — | Aluminum | Corona |
| | | | | hydroxide | |
| | 21 | Present | — | Aluminum | Corona |
| | | | | hydroxide | |
| Comp. Ex. | 1 | — | Present | Aluminum | — |
| | | | | hydroxide | |
| | 2 | Present | — | Aluminum | Corona |
| | | | | hydroxide | |
| | 3 | Present | — | Aluminum | Corona |
| | | | | hydroxide | |
| | 4 | Present | Present | Silicone | — |
| | | | | resin | |
| | 5 | Present | Present | — | Corona |

Next, using the thermosensitive recording media of Examples 1 to 21 and Comparative Examples 1 to 5, “solvent rub resistance”, “color developing sensitivity”, “visibility”, “tear resistance”, “temporal color fade resistance”, “light resistance”, “printability”, and “bindability” were evaluated. The results are presented in Tables 2-1 and 2-2 below.

(Solvent Rub Resistance)

Using a thermosensitive printer (apparatus name: DMX-I-4308, available from DATA MAX Co., Ltd.), printing was performed on the thermosensitive recording media produced in Examples 1 to 21 and Comparative Examples 1 to 5 at a printing speed of 2 inches/s at a printing density of 10, to obtain test samples. Next, a cotton cloth immersed in ethanol having a concentration of 99% by mass was set on a holder (with a plane of 20 mm in width and 50 mm in depth) of a friction tester (instrument name: FR-2, available from Suga Test Instruments Co., Ltd.), and a friction test including a hundred go-and-return cycles was performed with a load of 100 gf/cm² applied on the transparent base material side of each thermosensitive recording medium. The density of the printed portion of each test sample was measured before and after the test with a reflection density measuring instrument (instrument name: MACBETH RD-914, available from Gretag-Macbeth Ltd.). A printed portion remaining ratio was calculated according to a formula described below, and “solvent rub resistance” was evaluated according to the evaluation criteria described below. “Solvent rub resistance” of “C”, “B”, and “A” levels is a trouble-free level for practical use.

Printed portion remaining ratio=(density of printed portion after test)/(density of printed portion before test)×100

<Evaluation criteria>

A: The printed portion remaining ratio was 90% or higher.

B: The printed portion remaining ratio was 80% or higher but lower than 90%.

C: The printed portion remaining ratio was 75% or higher but lower than 80%.

D: The printed portion remaining ratio was lower than 75%.

(Color Developing Sensitivity)

Using a thermosensitive printer (apparatus name: TH-PMD, available from Okura Denki), printing was performed on the thermosensitive recording media produced in Examples 1 to 21 and Comparative Examples 1 to 5 with an energy of 0.4 mJ/dot applied, and the density of the printed portion was measured with a reflection density measuring instrument. Further, using a thermal gradient tester (instrument name: HG-100-2, available from Toyo Seiki Seisaku-sho, Ltd.), the thermosensitive recording media were caused to develop a color at 150 degrees C. at 2 kgf for 2 seconds. The color developing density was measured with a reflection density measuring instrument and used as a maximum color developing density. The reflection density of the printed portion printed by the thermosensitive printer and the maximum color developing density were compared, to evaluate “color developing sensitivity” according to the evaluation criteria described below. “Color developing sensitivity” of “C”, “B”, and “A” levels is a trouble-free level for practical use. <Evaluation criteria>

A: The color was developed to the maximum color developing density.

B: The color was developed to higher than or equal to 90% of the maximum color developing density.

C: The color was developed to higher than or equal to 80% of the maximum color developing density.

D: The color was developed to lower than 80% of the maximum color developing density.

(Visibility)

Using a thermosensitive printer (apparatus name: DMX-I-4308, available from DATA MAX Co., Ltd.), printing was performed on the thermosensitive recording media produced in Examples 1 to 21 and Comparative Examples 1 to 5 at a printing speed of 2 inches/s at a printing density of 10. Visibility of the printed characters was judged visually. The ratio between the number of printed characters and the number of characters visually recognized successfully was calculated, to evaluate “visibility” according to the evaluation criteria described below. “Visibility” of “C”, “B”, and “A” levels is a trouble-free level for practical use.

<Evaluation criteria>

A: The portion successfully recognized was 100%.

B: The portion successfully recognized was 85% or higher.

C: The portion successfully recognized was 70% or higher.

D: The portion successfully recognized was lower than 70%.

(Tear resistance)

Using a thermosensitive printer (apparatus name: TH-PMD, available from Okura Denki), printing was performed on the thermosensitive recording media produced in Examples 1 to 21 and Comparative Examples 1 to 5 with an energy of from 0.1 mJ/dot through 0.4 mJ/dot applied. Presence or absence of occurrence of tearing, peeling, or curling due to sticking of the transparent base material with the thermal head was judged visually, to evaluate “tear resistance” according to the evaluation criteria described below. As for Comparative Example 1, presence or absence of peeling or curing of the coated layers such as the thermosensitive recording layer and the barrier layer due to printing was judged visually.

<Evaluation criteria>

A: No tearing, peeling, or curling occurred.

B: No tearing, peeling, or curling occurred (but sticking occurred at some portion).

C: No tearing, peeling, or curling occurred (but sticking occurred).

(Temporal Color Fade Resistance)

With a thermosensitive printer (apparatus name: DMX-I-4308, available from DATA MAX Co., Ltd.), printing was performed on the thermosensitive recording media produced in Examples 1 to 21 and Comparative Examples 1 to 5 at a printing speed of 2 inches/s at a printing density of 10, to obtain test samples. The density of the printed portion of each test sample was measured with a reflection density measuring instrument. Subsequently, the test samples were exposed to an environment of 40 degrees C. and 90% RH for 24 hours, and then the density of the printed portion was measured again. A printed portion remaining ratio was calculated based on the densities of the printed portion before and after the test, and “temporal color fade resistance” was evaluated according to the evaluation criteria described below. “Temporal color fade resistance” of “C”, “B”, and “A” levels is a trouble-free level for practical use.

<Evaluation criteria>

A: The printed portion remaining ratio was 90% or higher.

B: The printed portion remaining ratio was 80% or higher but lower than 90%.

C: The printed portion remaining ratio was 75% or higher but lower than 80%.

D: The printed portion remaining ratio was lower than 75%.

(Light Resistance)

The thermosensitive recording media produced in Examples 1 to 21 and Comparative Examples 1 to 5 were subjected to a test of being irradiated with light of a Xe lamp at an illuminance of 0.35 W/m² at a chamber temperature of 45 degrees C. for 24 hours using a weather ometer (instrument name: CI3000, available from Atlas). A color difference ΔE between before and after the test was calculated according to a formula described below based on L*, a*, and b* values of the background, and “light resistance” was evaluated according to the evaluation criteria described below.

(Color difference ΔE)={(L*₂−L*₁)+(a*₂−a*₁)+(b*₂−b*₁)}\hat{ }(½)

*L*₁, a*₁, and b*₁: L*, a*, and b* values before the irradiation test

L*₂, a*₂, and b*₂: L*, a*, and b* values after the irradiation test

<Evaluation criteria>

A: ΔE<2.0

B: 2.0≤ΔE

(Printability)

With an RI tester, an UV colored ink (product name: BEST CURE UV TML-2 red/indigo, available from T&K TOKA Co., Ltd.) was coated over the protective layer of the thermosensitive recording media produced in Examples 1 to 21 and Comparative Examples 1 to 5 at an ink gauge of 6 at a printing speed of 1,000 rpm such that the amount of the ink to be attached would be 6 g/m². Printing was effected by irradiating and curing the ink with ultraviolet rays. A cellulose tape with a width of 18 mm (product name: CT18, available from Nichiban Co., Ltd.) was pasted over the printed samples along the printing flow direction in a manner to not allow bubbles to enter. Three-step methods of (i) slowly peeling the cellulose tape at an angle of 180 degrees, (ii) slowly peeling the cellulose tape at an angle of 90 degrees, and (iii) quickly peeling the cellulose tape an angle of 90 degrees were continuously performed, to visually judge the peeling condition of the printed image and evaluate “printability” according to the evaluation criteria described below.

<Evaluation criteria>

A: No peeling occurred in all of (i) to (iii).

B: No peeling occurred in the (i) and (ii) steps, but peeling occurred in the (iii) step.

C: Peeling occurred in the (i) or (ii) step.

(Bindability)

A cellulose tape with a width of 18 mm (product name: CT18, available from Nichiban Co., Ltd.) was pasted over the barrier layer of the thermosensitive recording medium of Example 1, over the support layer of the thermosensitive recording media of Example 3 and Comparative Examples 1, 4, and 5, and over the tackifier layer of the thermosensitive recording media of the other Examples and Comparative Examples along the printing flow direction in a manner to not allow bubbles to enter. Three-step methods of (i) slowly peeling the cellulose tape at an angle of 180 degrees, (ii) slowly peeling the cellulose tape at an angle of 90 degrees, and (iii) quickly peeling the cellulose tape an angle of 90 degrees were continuously performed, to visually judge the peeling condition between the transparent base material and the thermosensitive recording layer and evaluate “bindability” according to the evaluation criteria described below.

<Evaluation criteria>

A: No peeling occurred in all the steps, or peeling occurred only in the (iii) step.

B: No peeling occurred in the (i) step, but peeling occurred in the (ii) step.

C: Peeling occurred in the (i) step.

(Total Evaluation)

The lowest grade among the grades achieved in the evaluations described above was employed as the total evaluation. The result is presented in Table 2-2.

TABLE 2-1

| | | Evaluation result | | | | |
|---|---|---|---|---|---|---|
| | | Solvent rub resistance | | Color developing | | Tear |
| | | Printed portion | | sensitivity | Visibility | resistance |
| | | remaining ratio (%) | Judgement | Judgment | Judgment | Judgment |
| Ex. | 1 | 95 | A | C | B | A |
| | 2 | 95 | A | C | B | A |
| | 3 | 96 | A | C | B | A |
| | 4 | 94 | A | B | B | A |
| | 5 | 96 | A | A | A | A |
| | 6 | 94 | A | A | A | C |
| | 7 | 95 | A | A | A | B |
| | 8 | 96 | A | B | B | A |
| | 9 | 96 | A | C | C | A |
| | 10 | 95 | A | C | C | A |
| | 11 | 95 | A | B | B | A |
| | 12 | 95 | A | A | A | A |
| | 13 | 95 | A | A | A | A |
| | 14 | 94 | A | A | A | A |
| | 15 | 95 | A | A | A | A |
| | 16 | 96 | A | A | A | A |
| | 17 | 95 | A | A | A | A |
| | 18 | 95 | A | A | A | A |
| | 19 | 95 | A | A | A | A |
| | 20 | 95 | A | A | A | A |
| | 21 | 95 | A | A | A | A |
| Comp. Ex | 1 | 72 | D | A | A | A |
| | 2 | 95 | A | D | D | A |
| | 3 | 95 | A | D | D | A |
| | 4 | 94 | A | A | B | B |
| | 5 | 95 | A | A | B | B |

TABLE 2-2

| | | Evaluation result | | | | | | |
|---|---|---|---|---|---|---|---|---|
| | | Temporal color fade | | | | | | |
| | | resistance | | | | | | |
| | | Printed | | | | | | |
| | | portion | | Light resistance | | | | |
| | | remaining | | Background | | Printability | Bindability | Total |
| | | ratio (%) | Judgement | ΔE | Judgment | Judgment | Judgment | evaluation |
| Ex. | 1 | 100 | A | 2.32 | B | B | C | C |
| | 2 | 91 | A | 2.32 | B | B | C | C |
| | 3 | 91 | A | 2.30 | B | B | C | C |
| | 4 | 93 | A | 2.30 | B | B | C | C |
| | 5 | 97 | A | 2.31 | B | B | C | C |
| | 6 | 95 | A | 2.33 | B | B | A | C |
| | 7 | 95 | A | 2.33 | B | B | A | B |
| | 8 | 95 | A | 2.29 | B | B | A | B |
| | 9 | 95 | A | 2.26 | B | B | A | C |
| | 10 | 81 | B | 2.30 | B | B | A | C |
| | 11 | 88 | B | 2.30 | B | B | A | B |
| | 12 | 95 | A | 2.30 | B | B | A | B |
| | 13 | 96 | A | 2.30 | B | B | A | B |
| | 14 | 95 | A | 2.30 | B | C | A | C |
| | 15 | 96 | A | 2.30 | B | A | A | B |
| | 16 | 95 | A | 2.30 | B | A | B | B |
| | 17 | 95 | A | 2.30 | B | A | A | B |
| | 18 | 85 | B | 2.28 | B | A | A | B |
| | 19 | 95 | A | 2.30 | B | A | A | B |
| | 20 | 96 | A | 1.79 | A | A | A | A |
| | 21 | 96 | A | 1.20 | A | A | A | A |
| Comp. | 1 | 94 | A | 2.35 | B | A | A | D |
| Ex | 2 | 68 | D | 2.29 | B | A | A | D |
| | 3 | 70 | D | 2.30 | B | A | A | D |
| | 4 | 65 | D | 2.36 | B | C | B | D |
| | 5 | 73 | D | 2.33 | B | B | A | D |

Aspects of the present disclosure are as follows, for example.

<1> A thermosensitive recording medium including:

a transparent base material;

a thermosensitive recording layer over the transparent base material; and

a barrier layer over the thermosensitive recording layer,

wherein the barrier layer contains hollow particles and a binder resin, and

wherein when thermal energy is applied to the thermosensitive recording layer from a surface of the thermosensitive recording layer having the transparent base material, the thermosensitive recording layer develops a color.

<2> The thermosensitive recording medium according to <1>,

wherein the barrier layer contains at least any one selected from the group consisting of polyvinyl acetate, polyurethane, polyacrylic acid, polyacrylic acid ester, vinyl chloride-vinyl acetate copolymers, polybutyl methacrylate, ethylene-vinyl acetate copolymers, styrene-butadiene copolymers, and styrene-butadiene-acrylic copolymers.

<3> The thermosensitive recording medium according to <1> or <2>, wherein an average thickness of the transparent base material is 4 micrometers or greater but 25 micrometers or less.

<4> The thermosensitive recording medium according to any one of <1> to <3>, wherein the transparent base material contains polyethylene terephthalate.

<5> The thermosensitive recording medium according to any one of <1> to <4>, further including

a tackifier layer over the barrier layer.

<6> The thermosensitive recording medium according to any one of <1> to <5>, further including

a heat-resistant layer over a surface of the transparent base material opposite to a surface of the transparent base material having the thermosensitive recording layer.

<7> The thermosensitive recording medium according to <6>, wherein the heat-resistant layer contains at least any one of itaconic acid-modified polyvinyl alcohol and polyamide epichlorohydrin resin.

<8> The thermosensitive recording medium according to <6> or <7>, wherein at least any one of the transparent base material, the thermosensitive recording layer, and the heat-resistant layer contains an ultraviolet absorber.

<9> The thermosensitive recording medium according to any one of <1> to <8>, wherein an amount of the barrier layer attached is 0.5 g/m² or greater but 10.0 g/m² or less.

<10> The thermosensitive recording medium according to any one of <1> to <9>, wherein a rate of hollowness of the hollow particles is 45% or higher.

<11> The thermosensitive recording medium according to any one of <5> to <10>, including

release paper over the tackifier layer.

<12> The thermosensitive recording medium according to any one of <1> to <10>, including

a release layer over the transparent base material.

<13> A thermosensitive recording medium producing method including: forming a thermosensitive recording layer over a transparent base material; and forming a barrier layer containing hollow particles and a binder resin over the thermosensitive recording layer.

<14> An article including

the thermosensitive recording medium according to any one of <1> to <12>.

The thermosensitive recording medium according to any one of <1> to <12>, the thermosensitive recording medium producing method according to <13>, and the article according to <14> can solve the various problems in the related art and can achieve the object of the present disclosure.

### REFERENCE SIGNS LIST

1: thermosensitive recording medium

11: transparent base material

12: thermosensitive recording layer

13: barrier layer

14: tackifier layer

15: release paper

16: release layer

21: heat source

1-14. (canceled)

15. A thermosensitive recording medium, comprising:
a transparent base material;
a thermosensitive recording layer over the transparent base material; and
a barrier layer over the thermosensitive recording layer,
wherein the barrier layer comprises hollow particles and a binder resin, and
wherein when thermal energy is applied to the thermosensitive recording layer via the transparent base material, the thermosensitive recording layer develops a color.

16. The thermosensitive recording medium according to claim 15,
wherein the barrier layer comprises at least any one selected from the group consisting of polyvinyl acetate, polyurethane, polyacrylic acid, polyacrylic acid ester, vinyl chloride-vinyl acetate copolymers, polybutyl methacrylate, ethylene-vinyl acetate copolymers, styrene-butadiene copolymers, and styrene-butadiene-acrylic copolymers.

17. The thermosensitive recording medium according to claim 15,
wherein an average thickness of the transparent base material is 4 micrometers or greater but 25 micrometers or less.

18. The thermosensitive recording medium according to claim 15,
wherein the transparent base material comprises polyethylene terephthalate,

19. The thermosensitive recording medium according to claim 15, further comprising
a tackifier layer over the barrier layer.

20. The thermosensitive recording medium according to claim 15, further comprising
a heat-resistant layer over a surface of the transparent base material opposite to a surface of the transparent base material having the thermosensitive recording layer.

21. The then nosensitive recording medium according to claim 20,
wherein the heat-resistant layer comprises at least any one of itaconic acid-modified. polyvinyl alcohol and polyamide epichlorohydrin resin.

22. The thermosensitive recording medium according to claim 20,
wherein at least any one of the transparent base material, the thermosensitive recording layer, and the heat-resistant layer comprises an ultraviolet absorber.

23. The thermosensitive recording medium according to claim 15,
wherein an amount of the barrier layer attached is 0.5 g/m² or greater but 10.0 g/m² or less.

24. The thermosensitive recording medium according to claim 15,
wherein a rate of hollowness of the hollow particles is 45% or higher.

25. The thermosensitive recording medium according to claim 19, comprising
release paper over the tackifier layer.

26. The thermosensitive recording medium according to claim 15, comprising
a release layer over the transparent base material.

27. The thermosensitive recording medium according to claim 15,
wherein a volume average particle diameter of the hollow particles is 0.4 micrometers or greater but 10 micrometers or less.

28. The thermosensitive recording medium according to claim 15,
wherein a content of the hollow particles is 35% by mass or greater but 80% by mass or less relative to the binder resin.

29. A thermosensitive recording medium producing method, comprising:
forming a thermosensitive recording layer over a transparent base material; and
forming a barrier layer that comprises hollow particles and a binder resin over the thermosensitive recording layer,
wherein a rate of hollowness of the hollow particles represented by Formula below is 45% or higher,
rate of hollowness (%)=[(volume of hollow portion)/(volume of hollow particle)]×100.

30. An article, comprising
the thermosensitive recording medium according to claim 15.

31. An image recording method for a thermosensitive recording medium that comprises a transparent base material, a thermosensitive recording layer over the transparent base material, and a. barrier layer over the thermosensitive recording layer, wherein the barrier layer comprises hollow particles and a binder resin, the image recording method comprising:
applying thermal energy to the thermosensitive recording layer via the transparent base material.
